(19) United States
(12) Patent Application Publication
(10) Pub. No.: US 2008/0225714 A1
(43) Pub. Date: Sep. 18, 2008

(54) DYNAMIC LOAD BALANCING

(75) Inventor: Martin Denis, Vaudreuil (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/684,866

(22) Filed: Mar. 12, 2007

(51) Int. Cl. H04J 3/14

(52) U.S. Cl. 370/232

(57) ABSTRACT

A system, method and associated resource balancer function for calculating a resource attribution proposal to be used in a load balancing mechanism supported by a plurality of monitored Service Nodes (SN). At the resource balancer function, receiving an updated remaining capacity value from a first SN of the plurality of SN, storing a remaining capacity value for the first SN from the updated remaining capacity value and calculating the resource attribution proposal between the plurality of SN based on the stored remaining capacity values.

### TECHNICAL FIELD

The present invention relates to dynamic load balancing and, more particularly, to dynamic load distribution based on exchanged load measurement.

### BACKGROUND

Load balancing is used in the context of networked service provisioning in order to enhance the capabilities of response to service requests. A general purpose of a load balancing mechanism is to treat a volume of service requests that exceeds the capabilities of a single node. The load balancing mechanism also enables enhanced robustness as it usually involves redundancy between more than one node. A typical load balancing mechanism includes a load balancing node, which receives the service requests and forwarding each of them towards further service nodes. The distribution mechanism is a major aspect of the load balancing mechanism.

The simplest distribution mechanism is equal distribution (or round-robin distribution) in which all service nodes receive, in turn, an equal number of service requests. It is flawed since service nodes do not necessarily have the same capacity and since service request do not necessarily involve the same resource utilization once treated in a service node.

A proportional distribution mechanism takes into account the capacity of each service node, which is used to weight the round-robin mechanism. One problem of the proportional distribution mechanism is that it does not take into account potential complexity variability from one service request to another. Furthermore, it does not address capability modification in service nodes. This could occur, for instance, following addition or subtraction of resources on the fly (e.g., due to hardware modification or shared service provisioning configuration) or since the resource utilization is non-linear in view of the number of service requests.

Another distribution mechanism could be based on systematic pooling of resource availability. The pooling involves a request for current system utilization from the load balancing node and a response from each service node towards the load balancing node. The pooling frequency affects the quality of the end result. The pooling mechanism is based on snap shots (or instant view) of system utilization. Thus, a high frequency of pooling request is required to obtain a significant image of the node's capacity. However, a too frequent pooling is costly on nodes resources and network utilization while a too infrequent pooling is insignificant. Furthermore, the pooling mechanism, to be effective, needs to identify a number of indicators of the node's utilization. A low number of indicators is likely to lead to misevaluation of node's capability and a high number of indicators will result in high cost for each pooling event. Combined with the frequency problem, the pooling mechanism is thus likely to be either a high cost distribution mechanism or low relevance distribution mechanism. In the best case scenario, the pooling mechanism could be adjusted to be effective enough in a very specific context, but is likely to fail if a parameter of execution is changed (e.g., new service or new type of service requests not involving the same mix of resource utilization, different sharing of node's resources between more than one service affecting the node's performance, etc.).

As can be appreciated, the current load balancing distribution mechanism are not capable of effectively adjusting to changing execution environment. The present invention aims at providing a solution that would enhance load balancing distribution.

### SUMMARY

The present invention presents a solution that proposes adjustments to the load balancing distribution dynamically in view of the remaining capacity of service nodes used by a load balancing mechanism.

A first aspect of the present invention is directed to a resource balancer function in a load balancing mechanism comprising a plurality of monitored Service Nodes (SN). The resource balancer function comprises a resource statistics database and a resource calculator module. The resource statistics database receives an updated remaining capacity value from a first SN of the plurality of SN and stores a remaining capacity value for the first SN from the updated remaining capacity value. The resource calculator module calculates a resource attribution proposal between the plurality of SN based on the stored remaining capacity values.

A second aspect of the present invention is directed to a method for calculating a resource attribution proposal to be used in a load balancing mechanism comprising a plurality of monitored Service Nodes (SN) and a resource balancer function. The method comprises steps of, at the resource balancer function, receiving an updated remaining capacity value from a first SN of the plurality of SN, storing a remaining capacity value for the first SN from the updated remaining capacity value and calculating the resource attribution proposal between the plurality of SN based on the stored remaining capacity values.

A third aspect of the present invention is directed to a system for providing a load balancing mechanism comprising a plurality of monitored Service Nodes (SN). The system comprising a resource balancer function that receives an updated remaining capacity value from a first SN of the plurality of SN, stores a remaining capacity value for the first SN from the updated remaining capacity value and calculates a resource attribution proposal between the plurality of SN based on the stored remaining capacity values.

### BRIEF DESCRIPTION OF THE DRAWINGS

A more complete understanding of the present invention may be gained by reference to the following ‘Detailed description’ when taken in conjunction with the accompanying drawings wherein:

FIG. 1 is an exemplary architecture diagram of a load balancing mechanism in accordance with the teachings of the present invention;

FIG. 2 is an exemplary nodal operation and flow chart of a load balancing mechanism in accordance with the teachings of the present invention;

FIG. 3 is an exemplary modular representation of a Resource Balancer function of a load balancing mechanism in accordance with the teachings of the present invention; and

FIG. 4 is an exemplary flow chart of a load balancing mechanism in accordance with the teachings of the present invention.

### DETAILED DESCRIPTION

The present invention provides an improvement over existing load balancing mechanisms. The invention presents a resource balancer function that calculates a resource attribution proposal based on remaining capacity values from Service Nodes of the load balancing mechanism. The Service Nodes of the load balancing mechanism are the executers of actions, tasks or service requests associated to one or more services provided at least in part via the load balancing mechanism. The remaining capacity values are received or fetched by the resource balancer function from the Service Nodes continuously, periodically or on a need basis. Remaining capacity value can be defined in many different ways, which largely depend on the context of the load balancing mechanism.

The present invention is capable of adapting to various definitions of remaining capacity values. For instance, a remaining capacity value can be obtained via a snap-shot or punctual measurement of resource usage. Alternatively, a remaining capacity value can be calculated over a determined period of measurement. In the context of tasks or service requests treatment, for instance, the remaining capacity could be a number of events that could have been handled during a last period of measurement or a number of free processor cycles during the last period of measurement. The period of measurement is likely set (e.g., via tests or theoretical knowledge) in view of the specificities of the load balancing mechanism (e.g., given the expected time spent on each request, the number of requests, etc.) and also in view of the sensitivity (performance commitment, availability commitment, etc.) of the service(s) making use of the load balancing mechanism.

The remaining capacity value can be obtained via measurement (number of free processor cycles, processor cache memory %, amount of free memory, queue length, hard disk %, hard disk cache %, etc.). The remaining capacity value can also be obtained, in a given node, by subtracting the number of treated events from a capacity of treatment of the node. The capacity of treatment for the given node can be obtained, for instance, from the minimum value between a physical capacity of the node (e.g., known from configuration or testing) and the maximum licensed capacity of the node (e.g., what the node has permission to treat). For instance, a node equipped for handling 50 events/second with a license for treating 40 requests/second would have a capacity value of 40 requests/second. More information on license distribution can be obtained from the US patent application “License distribution in a packet data network”, US11/432326. The capacity of treatment may also be linked to one specific service, service type or action assigned to the load balancing mechanism. The capacity is more likely static, but could change dynamically based on various events (e.g., the node serves a specific service as a standby node for which capacity is normally 0, but which is likely to change to a relevant value once the node becomes active). A Service Node may also only send the number of treated events knowing that the capacity of treatment is known to the resource balancer (e.g., sent once or known by configuration) thereby enabling the resource balancer to compute the remaining capacity. In that sense, sending a remaining capacity value can be interpreted as sending a number of treated events knowing that capacity of treatment is known and did not change. Depending upon the way each treated event is tracked, the number of treated events can be obtained, for instance, via log analysis, database query, by reading a counter (memory, register, etc.).

Remaining capacity values can be measured or calculated periodically by Service Nodes, e.g., every measurements period or every fifth period of measurement. Remaining capacity values are then sent to the resource balancer (or fetched thereby) continuously, periodically or, preferably, only in cases of substantial variation (e.g., more than 5% variation in remaining capacity value since last measurement or more than 3% variation in remaining capacity value compared to the average remaining capacity of the last 5 measurements). The range of variation amounting to substantial variation is to be evaluated (e.g., via tests or theoretical knowledge) in view of the sensitivity (performance commitment, availability commitment, etc.) of the service(s) making use of the load balancing mechanism.

The resource balancer thus calculates each resource attribution proposal based on remaining capacity values from Service Nodes of the load balancing mechanism. The resource attribution proposal can be articulated in many different ways, which do not affect the teachings of the present invention (e.g., proportion of events per Service Node, number of events per Service Node, a mix of % and #, etc.).

It may happen that the resource balancer did not receive updated remaining capacity values from one or more of the Service Nodes. It may then either be assumed that the node is working properly with sustained performance, that the node is not active anymore (e.g., if an agreed maximum time between remaining capacity values delivery is passed) or the resource balancer may simply send a request for updated remaining capacity values to the relevant Service Node(s). Likewise, the resource balancer may send period request for updated remaining capacity values to the Service Nodes that did not contribute within a specified period of time or before each calculation of resource distribution proposal. Furthermore, the resource balancer could have access to the remaining capacity value via a predefined or existing protocol and fetch the information in a Service Node without affecting the Service Node's service handler module (e.g., via a generic interface from the resource balancer to the Service Node(s), via Simple Network Management Protocol (SNMP) information, etc.).

The resource attribution proposal can be sent to a node of the load balancing mechanism receiving the events to be distributed thereby (e.g., Load Balancing Node). Preferably, the resource attribution proposal is sent only if there exists a significant variation compared to a currently active resource distribution scheme or to a previously sent resource attribution proposal (e.g., variation of at least 2% for at least two Service Nodes). The range of variation amounting to significant variation is to be evaluated (e.g., via tests or theoretical knowledge) in view of the sensitivity (performance commitment, availability commitment, etc.) of the service(s) making use of the load balancing mechanism.

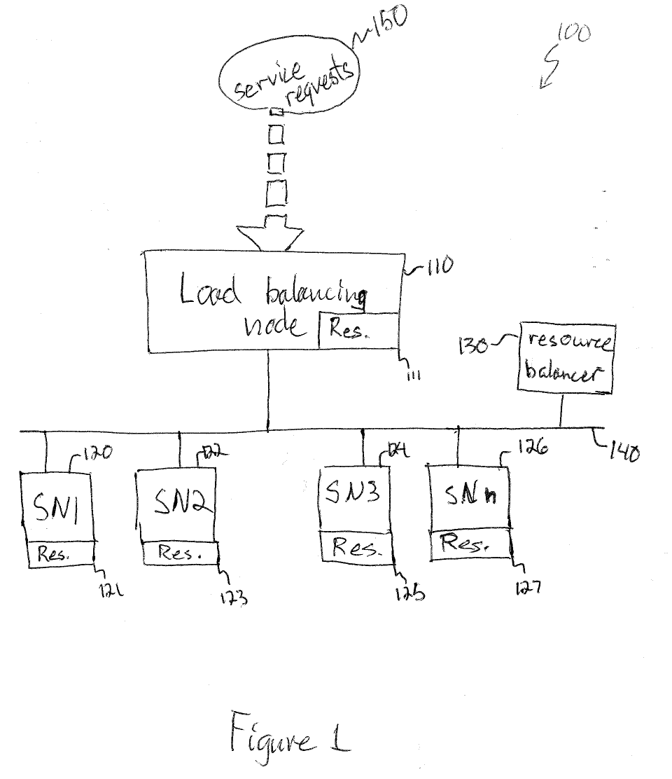

Reference is now made to the drawings in which FIG. 1 shows an exemplary system or architecture diagram of a load balancing mechanism 100 in accordance with the teachings of the present invention. The exemplary load balancing mechanism 100 of FIG. 1 is shown with a load balancing node 110 and a plurality of service nodes (SN1 120, SN2 122, SN3 124, SN4 126) and a resource balancer function 130. It should be understood that this only represents an example and that, for instance, more or less than four service nodes could be used in an actual implementation. Furthermore, the resource balancer function 130 is represented as independent node while it could be implemented as a module of the load balancing node 110 or of any of the services nodes 120-126. Likewise, the load balancing node 110 could be a module of one of the services nodes 120-126 (with or without the resource balancer function 130). Any combination of location of the load balancing node 110 and the resource balancer function 130 as module or node is also possible without impacting the invention. A connection 140 links the nodes 110-130, which is chosen for simplicity as the type of connection 140 does not affect the teachings of the invention. Moreover, the nodes 110-130 could be local or remote from each other (e.g., located in a single or different networks, domains or administrative systems).

The load balancing node 110, on FIG. 1, is shown receiving service requests 150 (or whatever type of sharable tasks), which are distributed to the service nodes 120-126. The service requests are received from one or more requester nodes (not shown) which may make use or not of results from the service requests. The service requests are distributed based on a resource allocation plan known to the load balancing node 110. A resource allocation plan proposal is calculated by the resource balancer function 130 based on remaining capacity from the various service nodes 120-126 (explicated below with reference to other figures). The service nodes each have, in the example of FIG. 1, a resource calculator module 121, 123, 125 and 127 that keeps track of the remaining capacity (other means of tracking remaining capacity are possible). The remaining capacity information is sent from the service nodes 120-126 to the resource balancer function 130 on the link 140. Alternatively, only information necessary to have the resource balancer function 130 to calculate the remaining capacity may be sent on the link 140 (e.g., throughput in a given period wherein the nominal capacity is known to the resource balancer function 130).

The calculated resource allocation plan proposal is sent from the resource balancer function 130 to the load balancing node 110 on the link 140, where it is adopted as is, modified before being adopted or rejected. A modification of the resource allocation proposal could be made, for instance, in view of information not known to the resource balancer function 130 or because the load balancing node 110 and the service nodes 120-126 support more than one services that do not all support ‘dynamic’ resource allocation plan as taught by the present invention. A rejection of the resource allocation proposal could be made, for instance, since the load balancing node 110 has no time to deal with a revision at the given reception point or because the difference in terms of attribution ratios does not meet a certain threshold. It should also be noted that the link 140 may not be used exactly as stated above if the resource balancer function 130 is collocated with the load balancing node 110 or with one of the service nodes 120-126.

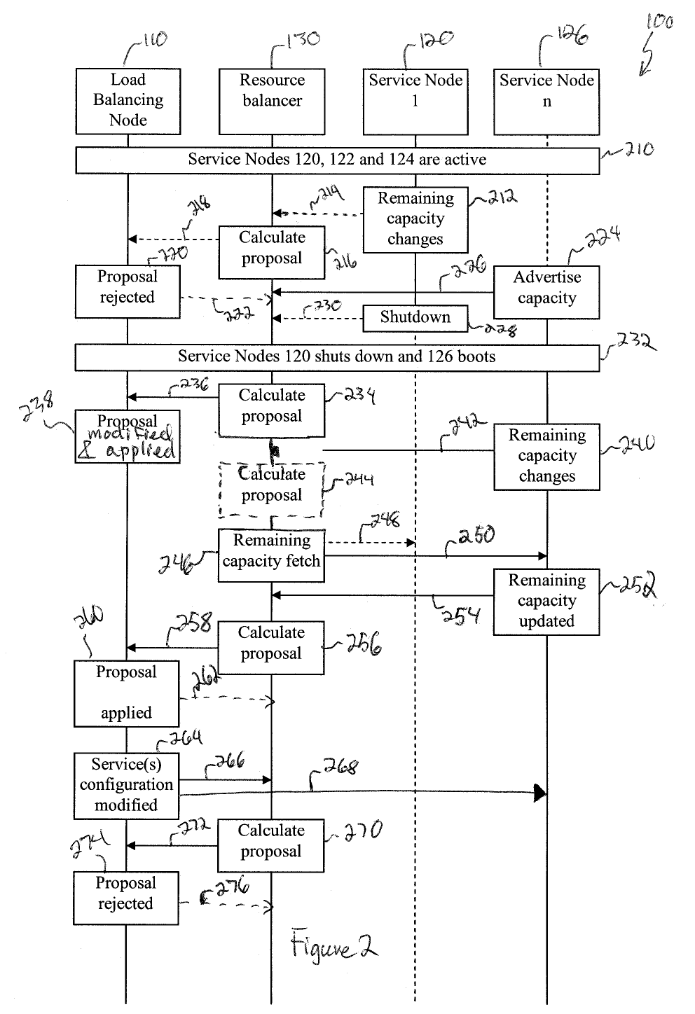

FIG. 2 shows an exemplary nodal operation and flow chart of the load balancing mechanism 100 in accordance with the teachings of the present invention. For the purpose of the example illustrated with FIG. 2, the remaining capacity of service nodes 120-126 is expressed by a number of service requests per minute. The attribution plan proposal (%) as shown in the next tables is calculated, for the purpose of the example of FIG. 2, as:

$$\frac{{RC}_{x}}{{\sum }_{1}^{n} {RC}_{i}}$$

Where x represents a service nodes from n services nodes managed by the resource balancer function 130. RCₓ is a remaining capacity value of the Service Node x.

The following information refers to the situation at the beginning of the example of FIG. 2 (210):

TABLE 1
Initial status

| Status | SN 1 120 | SN 2 122 | SN 3 124 | SN n 126 |
|---|---|---|---|---|
| Capacity | 70 | 70 | 70 | Unknown |
| Remaining | 10 | 10 | 10 | Not active |
| capacity | | | | |
| Attribution plan | 33.3 | 33.3 | 33.3 | 0 |
| proposal (%) | | | | |
| Attribution plan | 33.3 | 33.3 | 33.3 | 0 |
| applied (%) | | | | |

As can be noted, SN 2 122 and SN 3 124 are not represented on FIG. 2, for simplicity, as the theoretical example will of FIG. 2 does not involve any modification of their respective remaining capacity. It is assumed that the resource balancer function 130 is already aware of the remaining capacity (at least of active nodes) as expressed in table 1. The resource attribution plan applied by the load balancing node 110 (third row) and last proposed by the resource balancer function 130 (fourth row) are expressed in percentage in table 1, but could also be expressed by a number or by a different ratio (e.g., based on average number of request per period).

At 212, the remaining capacity of SN 1 120 changes from 10 to 11. This can be due, for instance, to a change in the capacity of the SN 1 120 (addition of processing power, license upgrade, etc.). SN 1 120 can send the new remaining capacity value of 11 (214) to the resource balancer function 130. It could also measure the variation from the previous remaining capacity or from the capacity and decide not to send the new value if it does not meet a predetermine threshold (e.g., 15% variation in remaining capacity compared to previous remaining capacity, variation of 2 in remaining capacity, variation of 2% of remaining capacity compared to capacity, etc.). The same threshold verification can apply to all modification of remaining capacity, but will not be mentioned further in the example of FIG. 2 for similar events.

In the example of FIG. 2, the new remaining capacity value of 11 is sent 214 to the resource balancer function 130. Upon reception of the new remaining capacity value, the resource balancer function 130 can calculate a resource attribution plan proposal (216) therewith. The resource balancer function 130 could also measure the variation from the previous remaining capacity or from the capacity and decide not to calculate if it does not meet a predetermine threshold (e.g., 15% variation in remaining capacity compared to previous remaining capacity, variation of 2 in remaining capacity, variation of 2% of remaining capacity compared to capacity, etc.). The same threshold verification can apply to all modification of remaining capacity, but will not be mentioned further in the example of FIG. 2 for similar events.

In the example of FIG. 2, the resource balancer function 130 calculates a resource attribution plan proposal 216 and obtains a resource attribution plan proposal of 35%, 32.5% and 32.5% respectively for SN 1 120, SN 2 122 and SN 3 124. The resource balancer function 130 can send the resource attribution plan proposal to the load balancing node 110 (218). The resource balancer function 130 could also measure the variation from the last proposed allocation plan or the active allocation plan and decide not to send if at least one of the attribution or the average of change does not meet a predetermine threshold (e.g., 15% variation compared to previous attribution, etc.). The same threshold verification can apply to all modification of attribution, but will not be mentioned further in the example of FIG. 2 for similar events.

In the example of FIG. 2, the resource balancer function 130 sends the resource attribution plan proposal to the load balancing node 110 218. The load balancing node 110 can then apply the proposed resource allocation plan (220). The load balancing node 110 could also measure the variation from the last proposed allocation plan or the active allocation plan and decide not to apply the proposal if at least one of the attribution or the average of change does not meet a predetermine threshold (e.g., 15% variation compared to previous attribution, etc.). The same threshold verification can apply to all modification of attribution, but will not be mentioned further in the example of FIG. 2 for similar events.

In the example of FIG. 2, the load balancing node 110 rejects the proposed resource allocation plan 220. It may then inform the resource balancer function 130 of the rejection (or of the active allocation plan) 222. Such an informational step may take place after each decision by the load balancing node 110 on resource allocation plan proposals from the resource balancer function 130. In the example of FIG. 2, the load balancing node 110 informs the resource balancer function 130 of the active allocation plan 222.

The following information refers to the situation after the first update (after 222) of the example of FIG. 2:

TABLE 2
First Update

| Status | SN 1 120 | SN 2 122 | SN 3 124 | SN n 126 |
|---|---|---|---|---|
| Capacity | 71 | 70 | 70 | Unknown |
| Remaining | 11 | 10 | 10 | Not active |
| capacity | | | | |
| Attribution plan | 35 | 35 | 32.5 | 0 |
| proposal (%) | | | | |
| Attribution plan | 33.3 | 33.3 | 33.3 | 0 |
| applied (%) | | | | |

Thereafter, the example of FIG. 2 follows with the SN n 126 booting up or starting its assignment to a service under responsibility of the resource balancer function 130. SN n 126, likely once ready to serve requests or potentially at any moment after boot, calculates 224 and sends 226 its remaining capacity value to the resource balancer function 130. If SN n 226 is starting, it is likely that the remaining capacity value will be equal to its overall capacity. That fact could be used, in some implementations and as stated above, to enable the service nodes to send only a number of treated events per period as the resource balancer 130 has capacity information readily available.

The example of FIG. 2 then follows with the SN 1 120 shutting down, crashing or simply stopping its assignment to a service under responsibility of the resource balancer function 130 (228). Depending if it is a graceful shut down or a crash or depending on the configuration, SN 1 120 can optionally inform (230) the resource balancer function 130 of the shutdown 228 (e.g., ‘count me out’ message, remaining capacity is null, capacity=0, etc.). The invention, however, does not rely on the message 230 for proper function as other mechanisms outside the scope of the present invention could provide the same information (e.g., ‘ping’ requests, heartbeat mechanism, lower layer connectivity information, failure to return results, etc.). In the example of FIG. 2, SN 1 120 does not informs the resource balancer function 130 of the shutdown 228. It should be noted that, in case of collocation of the resource balancer function 130 and a service node, the shutdown 228 and information 230 could have a different role to ensure that the resource balancer function 130 is transferred to a further service node. Alternatively, there could exist a high availability mechanism (outside the scope of the present invention) taking care of maintaining proper state of information related to the resource balancer function 130 and taking care of relocating or recreating the resource balancer function 130 in the further service node.

The resource balancer 130, upon reception of the new capacity 226, triggers a new attribution plan proposal calculation (234) and distribution (236) to the load balancing node 110. In typical circumstances, a single event is likely to trigger the calculation 234, but a certain amount of time could lapse (e.g., via a timer or simply because of delays in treating events) thereby enabling further events to be reported to the resource balancer function 130. The load balancing node 110, which is likely to know about the absence of SN 1 120 (failure to answer service requests), modifies the proposal received in 236 (by removing SN 1 120) and applies the modified attribution plan proposal 238 in the example of FIG. 2. It is also assumed for the sake of the example of FIG. 2 that the load balancing node 110 does not send the applied attribution plan to the resource balancer 130 (i.e., does not execute a step similar to 222).

The following information refers to the situation after 238 of the example of FIG. 2:

TABLE 3
After 238

| Status | SN 1 120 | SN 2 122 | SN 3 124 | SN n 126 |
|---|---|---|---|---|
| Capacity | 0 | 70 | 70 | 70 |
| Remaining | 0 | 10 | 10 | 70 |
| capacity | | | | |
| Attribution plan | 10 | 10 | 10 | 70 |
| proposal (%) | | | | |
| Attribution plan | 0 | 11.5 | 11.5 | 77 |
| applied (%) | | | | |

As can be anticipated, remaining capacity for SN n 126 will change as it starts receiving requests. Another possible solution could be, for the resource balancer 130 or SN n 126, to anticipate a probable sustained remaining capacity value for the SN n 126 based on historical information, configuration information and/or remaining capacity values from the other service nodes. No matter what the initial value could have been, SN n 126 has the capability to calculate (240) and send (242) an update of its remaining capacity value, as shown in the example of FIG. 2.

The resource balancer 130, upon reception of the new remaining capacity value 242, triggers a new attribution plan proposal calculation (244). Following the result of the calculation 244 or instead, it could be determined by the resource balancer function 130 that some service nodes (e.g., SN 1 120) did not report remaining capacity value for a certain period of time. The resource balancer 130 could then initiate fetch of remaining capacity values (246) from delinquent service node(s) or all service nodes, as in the example of FIG. 2, by sending requests 248 and 250 (requests to SN 2 122 and SN 3 124 not shown). A timer (not shown) could be used by the resource balancer 130 to wait for replies. SN n 126 recalculates its remaining capacity (or otherwise determines that the current value is good enough) 252 and sends the reply 254 to the resource balancer 230. Replies from SN 2 122 and SN 3 124 are not shown.

The resource balancer 130, upon reception of the new replies 254, triggers a new attribution plan proposal calculation (256) and distribution (258) to the load balancing node 110. The load balancing node 110 applies the attribution plan proposal 260 and then informs the resource balancer function 130 of the applied attribution plan (262—similar to 222) in the example of FIG. 2.

The following information refers to the situation after 262 of the example of FIG. 2:

TABLE 3
After 262

| Status | SN 1 120 | SN 2 122 | SN 3 124 | SN n 126 |
|---|---|---|---|---|
| Capacity | 0 | 70 | 70 | 70 |
| Remaining | 0 | 10 | 10 | 10 |
| capacity | | | | |
| Attribution plan | 0 | 33.3 | 33.3 | 33.3 |
| proposal (%) | | | | |
| Attribution plan | 0 | 33.3 | 33.3 | 33.3 |
| applied (%) | | | | |

The example of FIG. 2 then follows with a service configuration modification (264) executed on the load balancing node 110 and communicated to the resource balancer function 130 (266) and all or affected service nodes, if any (268; SN 2 122 and SN 3 124 are not shown). The service configuration modification 264 could state, for instance, the parameters of treatment for a new service that will be supported by the load balancing mechanism. Alternatively, the service configuration modification 264 could contain, for instance, new parameters to be applied to the current services, new license (i.e., capacities) for service nodes, etc. The service configuration modification 264 (e.g., via 268) could trigger remaining capacity recalculation (not shown) in service nodes.

The resource balancer 130, upon reception of the service configuration modification 266, could trigger a new attribution plan proposal calculation (270) and distribution (272) to the load balancing node 110. The load balancing node 110 could then apply or reject (as in the present example) the attribution plan proposal 274 and then inform the resource balancer function 130 of the currently applied attribution plan (276—similar to 222) as in the example of FIG. 2.

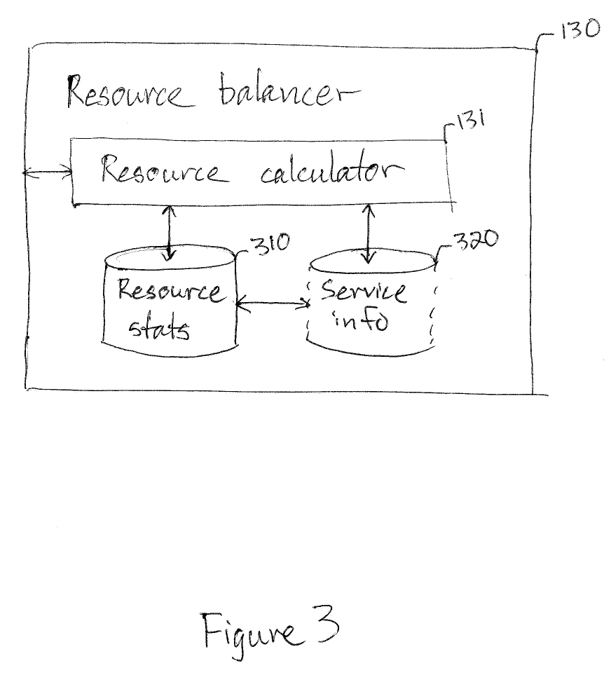

FIG. 3 shows an exemplary modular representation of a Resource Balancer function 130 of a load balancing mechanism in accordance with the teachings of the present invention. The resource balancer function 130 comprises a resource statistics database 310 and a resource calculator module 131.

The resource statistics database 310 receives an updated remaining capacity value from a first SN of the plurality of SN and stores a remaining capacity value for the first SN from the updated remaining capacity value. The resource calculator module 131 calculates a resource attribution proposal between the plurality of SN based on the stored remaining capacity values.

The resource balancer function may further comprise a service information database 320 that contains service identifiers of services delivered via the load balancing mechanism. In such a case, the remaining capacity values could be stored with a service identifier and the resource calculator module could calculate one resource attribution proposal per service identifier between the plurality of SN based on the stored remaining capacity values per service identifier.

The resource calculator module 131 may further compare previously stored remaining capacity values with updated remaining capacity values and, only if there exists a significant difference in at least one set of remaining capacity values, calculate the resource distribution proposal. For the purpose of the explanation, a set of remaining capacity values comprises a previously stored remaining capacity value of a specific SN from the plurality of SN and an updated remaining capacity value of the specific SN.

The resource statistics database 310 may further, if there exists a significant difference in at least one set of remaining capacity values, request an updated remaining capacity value from each SN of the plurality of SN except the specific SN before calculating the resource distribution proposal.

The resource calculator module 131 may further send the resource attribution proposal to a Load Balancing node (LB) of the load balancing mechanism. The LB is a node that receives a plurality of service requests to be executed by at least one SN from the plurality of SN. The LB further distributes the plurality of service requests based on the received resource distribution proposal. The resource calculator module 131 may further, before sending the resource attribution proposal to the LB, verify that a significant variation exists between the resource attribution proposal and a previously sent resource attribution proposal. Furthermore, the resource calculator module 131 may send the resource attribution proposal to the LB as a series of commands on one of a management and a Graphical User Interface port.

The LB may be collocated with the resource balancer function. The resource balancer function 130 may be collocated with one SN from the plurality of SN. The collocated SN may be elected from the plurality of SN using a known technique (e.g., first up is elected, lowest identifier or a combination of both, etc.).

The resource statistics database 310 may store a default remaining capacity value for each of the plurality of SN.

The resource statistics database 310 may further request an updated remaining capacity value from a specific SN of the plurality of SN. The resource statistics database 320 may further request an updated remaining capacity value from the specific SN upon expiration of a timer set on, for instance, either a delay between update reception or a stored remaining capacity value of the specific SN.

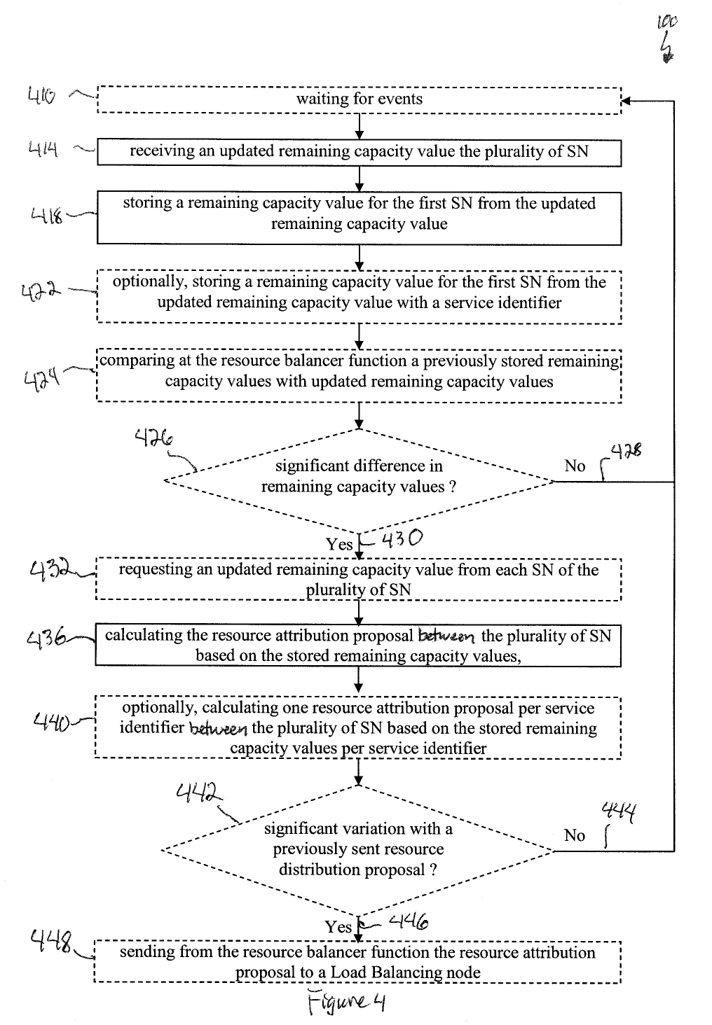

FIG. 4 shows an exemplary flow chart of a load balancing mechanism 100 in accordance with the teachings of the present invention. The example shown is for calculating a resource attribution proposal to be used in the load balancing mechanism 100, which comprises a plurality of monitored Service Nodes (SN) and a resource balancer function. In the example of FIG. 4, the core of the example is shown in complete lines while optional aspects of the example are shown in dashed boxes. The example on FIG. 4 is shown as event-driven. Step 410 shown is thus a stable state in which events are waited for. Then, the example follows with step 414 of receiving an updated remaining capacity value from a first SN. A remaining capacity value is therefore stored for the first SN from the updated remaining capacity value (418). Optionally, a service identifier may also be stored with the remaining capacity value (422). A default remaining capacity value may also be stored for each SN.

Comparison of a previously stored remaining capacity values with updated remaining capacity values can then occur (424). If there exists a significant difference in at least one set of remaining capacity values (426), then the next step can be executed (430). Otherwise (428), the next event is awaited (410). For the purpose of the example of FIG. 4, a set of remaining capacity values comprises a previously stored remaining capacity value of a specific SN from the plurality of SN and an updated remaining capacity value of the specific SN.

It is then possible to request (432) an updated remaining capacity value from each SN of the plurality of SN (except the specific SN) before proceeding with the step 436 of calculating the resource attribution proposal between the plurality of SN based on the stored remaining capacity values. One or more timers could be used to trigger requests (432) based on delay between reception of updated remaining capacity values or on the age of a remaining capacity values. In cases where a service identifier is stored with the remaining capacity values, more than one resource attribution proposal (e.g., one per service identifier) can be calculated (440).

A verification that a significant variation exists between the resource attribution proposal and a previously calculated resource distribution proposal (442) can then take place. If there is no significant difference (444), further events are awaited (410). If there exists a significant difference (446), sending of the resource attribution proposal to a load balancing node of the load balancing mechanism 100 can occur (448). Sending to the load balancing node can be performed, for instance, by sending a series of commands on a management or on a Graphical User Interface (GUI) port.

The innovative teachings of the present invention have been described with particular reference to numerous exemplary implantations. However, it should be understood that this provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

What is claimed is:

1. A resource balancer function in a load balancing mechanism comprising a plurality of monitored Service Nodes (SN), the resource balancer function comprising:
a resource statistics database that:
receives an updated remaining capacity value from a first SN of the plurality of SN;
stores a remaining capacity value for the first SN from the updated remaining capacity value; and
a resource calculator module that:
calculates a resource attribution proposal between the plurality of SN based on the stored remaining capacity values.

2. The resource balancer function of claim 1 further comprising a service information database that contains service identifiers of services delivered via the load balancing mechanism, wherein the remaining capacity values are stored with a service identifier and wherein the resource calculator module calculates one resource attribution proposal per service identifier between the plurality of SN based on the stored remaining capacity values per service identifier.

3. The resource balancer function of claim 1 wherein the resource calculator module further compares previously stored remaining capacity values with updated remaining capacity values and, if there exists a significant difference in at least one set of remaining capacity values, calculates the resource distribution proposal, wherein a set of remaining capacity values comprises a previously stored remaining capacity value of a specific SN from the plurality of SN and an updated remaining capacity value of the specific SN.

4. The resource balancer function of claim 3 wherein the resource statistics database further, if there exists a significant difference in at least one set of remaining capacity values, requests an updated remaining capacity value from each SN of the plurality of SN except the specific SN before calculating the resource distribution proposal.

5. The resource balancer function of claim 1 wherein the resource calculator module further sends the resource attribution proposal to a Load Balancing node (LB) of the load balancing mechanism, wherein the LB receives a plurality of service requests to be executed by at least one SN from the plurality of SN and distributes the plurality of service requests based on the received resource distribution proposal.

6. The resource balancer function of claim 5 wherein the resource calculator module further, before sending the resource attribution proposal to the LB, verifies that a significant variation exists between the resource attribution proposal and a previously sent resource distribution proposal.

7. The resource balancer function of claim 5 wherein the resource calculator module further sends the resource attribution proposal to the LB as a series of commands on one of a management and a Graphical User Interface port.

8. The resource balancer function of claim 5 wherein the LB is collocated with the resource balancer function.

9. The resource balancer function of claim 1 wherein one SN from the plurality of SN is collocated with the resource balancer function.

10. The resource balancer function of claim 9 wherein the collocated SN is elected from the plurality of SN using a known technique.

11. The resource balancer function of claim 1 wherein the resource statistics database stores a default remaining capacity value for each of the plurality of SN.

12. The resource balancer function of claim 1 wherein the resource statistics database further requests an updated remaining capacity value from a specific SN of the plurality of SN.

13. The resource balancer function of claim 12 wherein the resource statistics database further requests an updated remaining capacity value from the specific SN upon expiration of a timer set on one of a delay between update reception and a stored remaining capacity value of the specific SN.

14. A method for calculating a resource attribution proposal to be used in a load balancing mechanism comprising a plurality of monitored Service Nodes (SN) and a resource balancer function, the method comprising steps of:
at the resource balancer function, receiving an updated remaining capacity value from a first SN of the plurality of SN;
at the resource balancer function, storing a remaining capacity value for the first SN from the updated remaining capacity value; and
at the resource balancer function, calculating the resource attribution proposal between the plurality of SN based on the stored remaining capacity values.

15. The method of claim 14 wherein a plurality of service identifiers of services delivered via the load balancing mechanism are maintained in the resource balancer function, wherein the remaining capacity values are stored with a service identifier and wherein the method further comprises calculating at the resource balancer function one resource attribution proposal per service identifier between the plurality of SN based on the stored remaining capacity values per service identifier.

16. The method of claim 14 wherein further comprising comparing at the resource balancer function a previously stored remaining capacity values with updated remaining capacity values and, if there exists a significant difference in at least one set of remaining capacity values, calculating the resource distribution proposal, wherein a set of remaining capacity values comprises a previously stored remaining capacity value of a specific SN from the plurality of SN and an updated remaining capacity value of the specific SN.

17. The method of claim 16 further comprising verifying at the resource balancer function if there exists a significant difference in at least one set of remaining capacity values and, if so, requesting from the resource balancer function an updated remaining capacity value from each SN of the plurality of SN except the specific SN before calculating the resource distribution proposal.

18. The method of claim 14 further comprising sending from the resource balancer function the resource attribution proposal to a Load Balancing node (LB) of the load balancing mechanism, wherein the LB receives a plurality of service requests to be executed by at least one SN from the plurality of SN and distributes the plurality of service requests based on the received resource distribution proposal.

19. The method of claim 18 further comprising, before sending the resource attribution proposal to the LB, verifying at the resource balancer function that a significant variation exists between the resource attribution proposal and a previously sent resource distribution proposal.

20. The method of claim 18 further comprising sending from the resource balancer function the resource attribution proposal to the LB as a series of commands on one of a management and a Graphical User Interface port.

21. The method of claim 14 further comprising, at the resource balancer function, storing a default remaining capacity value for each of the plurality of SN.

22. The method of claim 14 further comprising at the resource balancer function requesting an updated remaining capacity value from a specific SN of the plurality of SN before calculating the resource attribution proposal.

23. The method of claim 22 further comprising at the resource balancer function requesting an updated remaining capacity value from the specific SN upon expiration of a timer set on one of a delay between update reception and a stored remaining capacity value of the specific SN.

24. A system for providing a load balancing mechanism comprising a plurality of monitored Service Nodes (SN), the system comprising:
a resource balancer function that:
receives an updated remaining capacity value from a first SN of the plurality of SN;
stores a remaining capacity value for the first SN from the updated remaining capacity value; and
calculates a resource attribution proposal between the plurality of SN based on the stored remaining capacity values.

25. The system of claim 24 further comprising a load balancing node that receives a plurality of service requests to be executed by at least one SN from the plurality of SN and distributes the plurality of service requests based on an applied resource distribution plan, wherein the resource balancer function further sends the resource attribution proposal to the load balancing node and the load balancing node applies the resource attribution proposal as the applied resource distribution plan.

26. The system of claim 25 wherein the resource balancer function further, before sending the resource attribution proposal to the load balancing node, verifies that a significant variation exists between the resource attribution proposal and a previously sent resource distribution proposal.

27. The system of claim 25 wherein the resource balancer function further sends the resource attribution proposal to the load balancing node as a series of commands on one of a management and a Graphical User Interface port.

28. The system of claim 25 wherein the load balancing node is collocated with the resource balancer function.

29. The system of claim 24 wherein one SN from the plurality of SN is collocated with the resource balancer function.

30. The system of claim 29 wherein the collocated SN is elected from the plurality of SN using a known technique.

31. The system of claim 24 wherein the resource balancer function stores a default remaining capacity value for each of the plurality of SN.

32. The system of claim 24 wherein the resource balancer function further requests an updated remaining capacity value from a specific SN of the plurality of SN.

33. The system of claim 32 wherein the resource balancer function further requests an updated remaining capacity value from the specific SN upon expiration of a timer set on one of a delay between update reception and a stored remaining capacity value of the specific SN.
